(19) United States
(12) Patent Application Publication
(10) Pub. No.: US 2015/0234547 A1
(43) Pub. Date: Aug. 20, 2015

(54) PORTALS FOR VISUAL INTERFACES

(71) Applicant: Microsoft Technology Licensing, LLC, Redmond, WA (US)

(72) Inventors: Donald A. Barnett, Monroe, WA (US); Romualdo T. Impas, Seattle, WA (US); Timothy P. Wantland, Bellevue, WA (US); Michael Bray, Bellevue, WA (US); Gonzalo Alberto Ramos, Kirkland, WA (US); Blaise Aguera y Arcas, Seattle, WA (US)

(21) Appl. No.: 14/182,781

(22) Filed: Feb. 18, 2014

(51) Int. Cl. G06F 3/0482; G06F 3/0484

(52) U.S. Cl. CPC G06F 3/0482; G06F 3/04847; G06F 3/04842

(57) ABSTRACT

One or more techniques and/or systems are provided for populating a scene of a visual interface with a portal. For example, one or more points of interest may be identified for the scene (e.g., a lake, a park, a condo, and/or other points of interest for a city scene). The scene may be populated with portals corresponding to the points of interest (e.g., a portal may have a semi-transparent perimeter compassing at least some of a point of interest, which may mitigate occlusion of the scene). A portal may be hydrated with imagery of a point of interest to provide a preview of the point of interest (e.g., a first portal for the lake may be hydrated with imagery of the lake). A user may seamlessly navigate between and/or explore scenes by selecting portals to transition the visual interface to new scenes depicting corresponding points of interest.

### BACKGROUND

Many applications and/or websites provide information through visual interfaces, such as maps. For example, a videogame may display a destination for a user on a map; a running website may display running routes through a web map interface; a mobile map app may display driving directions on a road map; a realtor app may display housing information, such as images, sale prices, home value estimates, and/or other information on a map; etc. Such applications and/or websites may facilitate various types of user interactions with maps. In an example, a user may zoom-in, zoom-out, and/or rotate a viewing angle of a map. In another example, the user may mark locations within a map using pinpoint markers (e.g., create a running route using pinpoint markers along the route). However, such pinpoint markers may occlude a surface of the map.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for populating a scene of a visual interface with a portal are provided herein. For example, a visual interface, depicting a scene, may be displayed. The scene may comprise a map, photography, a manipulatable object, a manipulatable space, a panorama, a rendering, an image, and/or any other type of visualization. In an example, a map service, remote to a client device, may provide visual information, such as mapping information, to the client device for display through the visual interface (e.g., the client device may display the visual interface through a map app, a map website, search results of a search charm and/or other map interfaces that may connect to and/or consume mapping information from the mapping service such as by using mapping service APIs and/or remote HTTP calls). In an example, a client device (e.g., a mobile map app; a running map application executing on a personal computer; etc.) may provide the visual information for display through the visual interface, such as where the visual information corresponds to user information (e.g., imagery captured by the user; a saved driving route; a saved search result map; a personal running route map, etc.)

One or more points of interest, such as a first point of interest, within the scene may be identified (e.g., a doorway into a restaurant depicted by a downtown scene of a city). For example, the first point of interest may be identified based upon availability of imagery for the first point of interest (e.g., users may have captured and shared photography of the restaurant) and/or based upon the first point of interest corresponding to an entity (e.g., a business, a park, a building, a driving intersection, and/or other interesting content). The scene may be populated with portals corresponding to the one or more points of interest. For example, a first portal, corresponding to the first point of interest, may be populated within the scene (e.g., the first portal may have a relatively thin linear shape, such as a circle, having a semi-transparent perimeter that encompasses at least some of the first point of interest). Responsive to receiving focus input associated with the first portal (e.g., the first portal may be hovered over by a cursor; the visual interface may be panned such that the first portal encounters a trigger zone such as a center line/zone; etc.), the first portal may be hydrated with imagery associated with the first point of interest to create a first hydrated portal (e.g., a display property of a portal user interface element may be set to an image, photography, a panorama, a rendering, an interactive manipulatable object, an interactive manipulatable space, and/or any other visualization). For example, a visualization depicting the inside of the restaurant may be populated within the first portal. In this way, a user may preview the restaurant to decide whether to further or more deeply explore additional imagery and/or other aspects (e.g., advertisements, coupons, menu items, etc.) of the restaurant. For example, responsive to receiving selection input associated with the first portal, the visual interface may be transitioned to a second scene associated with the first point of interest (e.g., the second scene may depict the inside of the restaurant). In this way, the user may freely navigate into buildings, underground such as into a subway, through walls, down a street, and/or other locations to experience frictionless traveling/viewing.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of populating a scene of a visual interface with a portal.

FIG. 2 is a component block diagram illustrating an exemplary system for populating a scene of a visual interface.

FIG. 3 is a component block diagram illustrating an exemplary system for hydrating a portal.

FIG. 4A is a component block diagram illustrating an exemplary system for hydrating a portal.

FIG. 4B is a component block diagram illustrating an exemplary system for hydrating a portal based upon a temporal modification input.

FIG. 5 is a component block diagram illustrating an exemplary system for navigating between scenes of a visual interface.

FIG. 6A is a component block diagram illustrating an exemplary system for facilitating visual navigation between a plurality of portals.

FIG. 6B is a component block diagram illustrating an exemplary system for facilitating visual navigation between a plurality of portals.

FIG. 6C is a component block diagram illustrating an exemplary system for facilitating visual navigation between a plurality of portals.

FIG. 7A is a component block diagram illustrating an exemplary system for facilitating a story mode.

FIG. 7B is a component block diagram illustrating an exemplary system for facilitating a story mode.

FIG. 7C is a component block diagram illustrating an exemplary system for facilitating a story mode.

FIG. 8 is a component block diagram illustrating an exemplary system for populating a scene of a kinetic map visual interface.

FIG. 9 is an illustration of an example of various portals.

FIG. 10 is an illustration of an exemplary computer readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for populating a scene of a visual interface with a portal are provided. For example, a scene may be populated with portals corresponding to points of interest of the scene (e.g., a park scene may correspond to a water fountain point of interest, a bird's nest point of interest, a jogging trail point of interest, etc.). A portal can generally have any shape and/or other properties (e.g. size, color, degree of translucency/transparency, etc.), and is not intended to be limited to the examples provided herein. A portal may be a circle, a square, a polygon, a rectangle, a rain drop, an adaptive shape that may change based upon a characteristic of a point of interest within the portal, etc. A portal may be semi-transparent and/or have a semi-transparent perimeter or border to delineate the portal from non-portal portions of the scene. The portal is thus discernable but does not occlude (or occludes to a relatively minor and/or variable degree) portions of the scene. A size of a portal may correspond to a ranking assigned to a point of interest by a search engine, such as a relatively larger size for a relatively high ranking point of interest (e.g., the Empire State Building for a search for sights to see in New York city) as compared to a relatively smaller size for a relatively lower ranking point of interest (e.g., a hotdog stand in New York city for a search for sights to see in New York city). A portal may comprise a graphics user interface element, such as a control object (e.g., an application object of an application, a web interface object of a website and/or other programming object(s) that may be used to visually represent a point of interest), having various properties and/or functionality. For example, a portal may comprise focus functionality, such that when a user hovers over the portal and/or otherwise interacts with the portal a visual state of the portal is modified (e.g., becomes less translucent, is highlighted, undergoes a color change, is zoomed-in, is hydrated with imagery, etc.). A portal may comprise a selection functionality (e.g., a selection state/method) that triggers a transition of the user interface from displaying the scene to displaying a new scene corresponding to the point of interest.

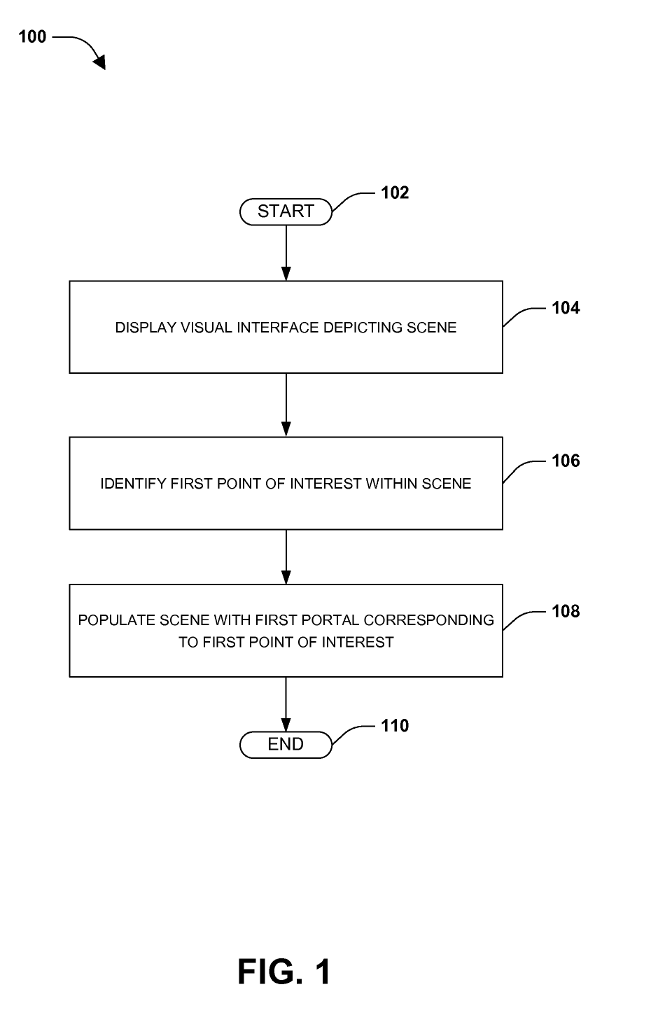

An embodiment of populating a scene of a visual interface with a portal is illustrated by an exemplary method 100 of FIG. 1. At 102, the method starts. At 104, a visual interface, depicting a scene, may be displayed. The scene may comprise a map, photography, an interactive manipulatable object (e.g., a 3D rendering of a statute), an interactive manipulatable space, a panorama, a rendering, an image, and/or any other type of visualization. For example, the scene may depict a street-side view of a museum and a park. In an example, a visualization server may have generated and provided the scene to a client device for display through the visual interface (e.g., a map app, a web browser, a photography app, and/or any other app or website). At 106, a first point of interest within the scene may be identified. For example, the first point of interest may correspond to a museum front door. In an example, one or more points of interest may be identified within the scene (e.g., a second point of interest corresponding to the park, a third point of interest corresponding to a gargoyle on the roof of the museum, etc.).

At 108, the scene may be populated with a first portal corresponding to the first point of interest. In an example, the scene may be populated with a plurality of portals corresponding to the one or more points of interest of the scene (e.g., a second portal for the second point of interest corresponding to the park, a third portal for the third point of interest corresponding to the gargoyle, etc.). In an example, the first portal comprises a semi-transparent perimeter that encompasses at least some of the first point of interest, which may mitigate occlusion of the scene (e.g., the first portal may have a relatively thin linear shape, such as a circle, which encompasses at least some of the museum front door and/or other portions of the front of the museum). Portals may or may not visually overlap within the scene (e.g., the first portal for the museum front door may overlap with the third portal for the gargoyle). Size, transparency, and/or display properties of portals may be modified, for example, based upon a point of interest density for the scene (e.g., portals may be displayed relatively smaller and/or more transparent if the scene is populated with a relatively large amount of portals, which may mitigate occlusion of the scene) and/or based upon point of interest rankings (e.g., a web search engine may determine that the park has a relatively high rank based upon search queries and/or browsing history of users, and thus may display the second portal at a relatively large size).

In an example, portals may be populated within the scene based upon time. For example, a temporal modification input may be received (e.g., a particular date, a time of day such as daylight or night, etc.). For example, the temporal modification input may correspond to 1978. Points of interest that do not correspond to the temporal modification input may be removed (e.g., the second portal for the park may be removed because the park was not built until 1982). The scene may be populated with one or more points of interest that correspond to the temporal modification input (e.g., a fourth portal for a fourth point of interest corresponding to a building that was in existence in 1978 may be displayed). In this way, points of interest may be exposed through portals based upon time.

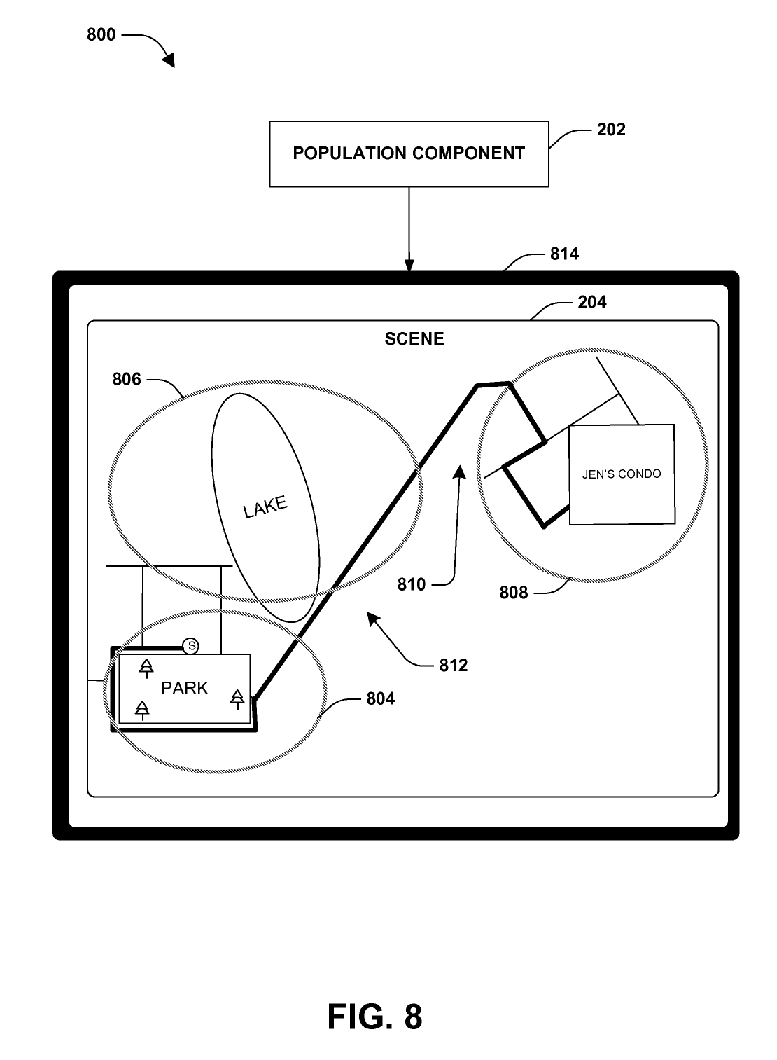

In an example where the visual interface corresponds to a kinetic map, portals may be displayed at a first scale and non-portal portions of the scene may be displayed at a collapsed scale smaller than the first scale (e.g., FIG. 8). For example, a portion of the screen containing a relatively uninteresting mile stretch of road between the museum and the park may be collapsed so that the first portal for the museum and the second portal for the park may be displayed relatively larger through the visual interface.

Portals may allow a user to preview “peek” into a point of interest before committing to traveling through the visual interface to the point of interest. In an example, focus input associated with the first portal may be received (e.g., hover over input associated with the first portal; navigation input for the scene that places the first portal within a trigger zone such as a center zone/line; etc.). Responsive to the focus input, the first portal may be hydrated with imagery corresponding to the first point of interest to create a first hydrated portal. The first hydrated portal may comprise an image, a panorama, 3D imagery, a rendering, photography, a streetside view, an interactive manipulatable object (e.g., the user may open, close, turn a nob, and/or manipulate other aspects of the museum front door), an interactive manipulatable space, and/or other imagery depicting the front of the museum. In an example, a transparency property of the first hydrated portal may be adjusted (e.g., the transparency may be increased as the user hovers away from the first portal with a cursor or as the user pans the scene such that the first portal moves away from the trigger zone or is de-emphasized), which may mitigate occlusion as the user expresses increasing disinterest in the first point of interest (e.g., by panning away). In an example, the imagery may depict the first point of interest according to a portal orientation that corresponds to a scene orientation of the scene (e.g., the museum front door may be depicted from a viewpoint of the scene). In an example, the imagery within the first portal may be modified based upon a temporal modification input (e.g., imagery depicting the museum at night may be used to hydrate the first portal based upon a nighttime setting; imagery depicting the museum in 1992 may be used to hydrate the first portal based upon a 1992-1996 time range; etc.)

In an example, visual navigation between one or more portals populated within the scene may be facilitated. A user may “flip” through portals (e.g., a relatively large amount of portals that may visually overlap) where a single portal is brought into focus (e.g., a size may be increased, a transparency may be decreased, the first portal may be brought to a front display position, etc.) one at a time to aid the user in distinguishing between points of interest. For example, for respective portals encountering a trigger zone of the visual interface (e.g., a portal overlapping the trigger zone above a threshold amount; a portal having a portal center point that is closer to a trigger zone than other portal center points of other portals are to the trigger zone; etc.), a portal may be hydrated while the portal encounters the trigger zone and may be dehydrated responsive to the portal no longer encountering the trigger zone. In an example, while hydrated, the portal may be displayed on top of one or more portals that overlap the portal.

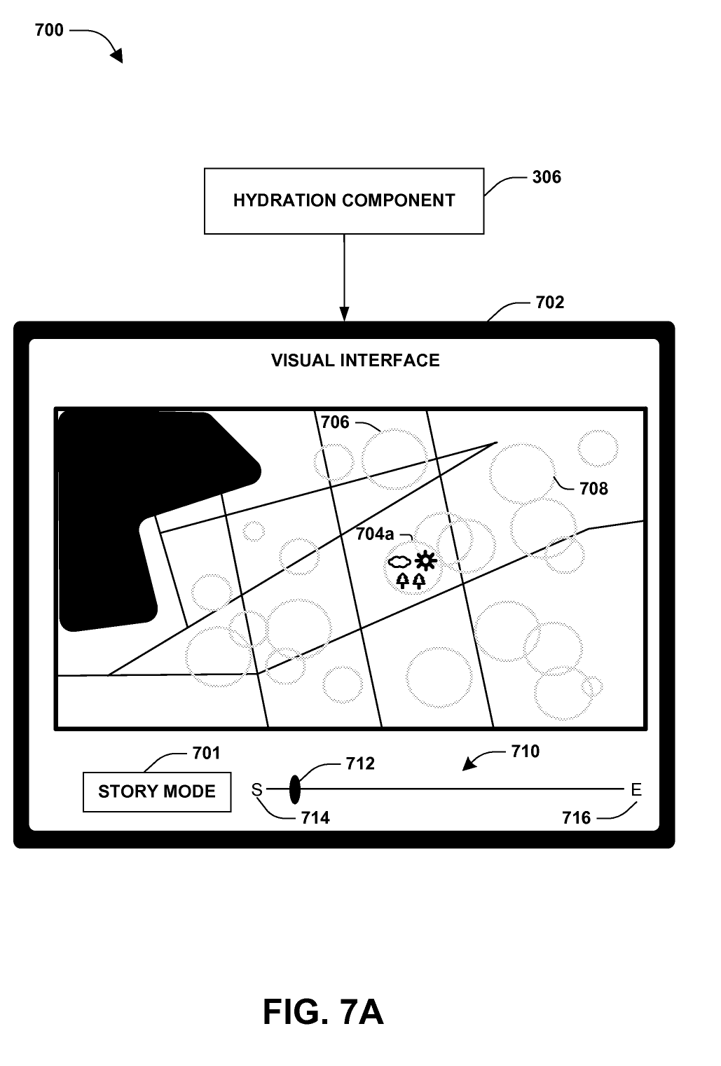

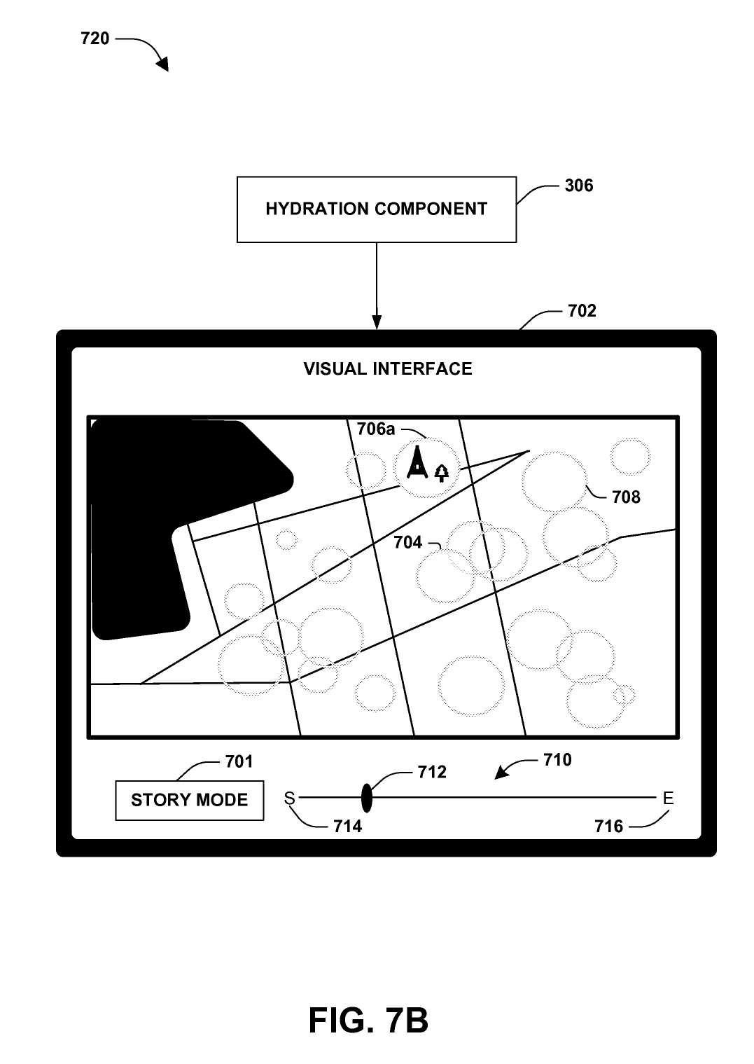

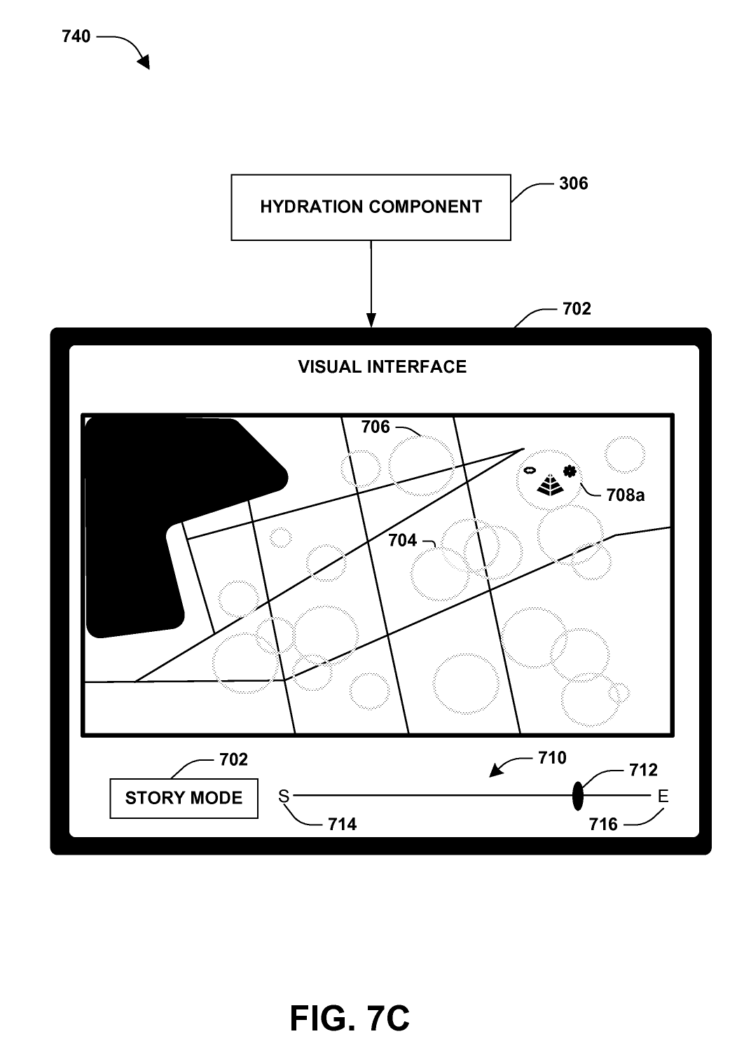

In an example, a story mode may be facilitated for points of interest within the scene (e.g., FIG. 7A-7C). For example, a story mode selection input may be received. The story mode selection input may correspond to one or more timeframes of a story (e.g., a story timeline interface may be displayed with a current time marker, corresponding to a current timeframe of the story, such that a user may move the current time marker along the timeline interface and/or the current time marker may be automatically moved along the timeline based upon a play story input). For respective timeframes of a story (e.g., a first timeframe may correspond to a first date/time, a second timeframe may correspond to a second date/time, and/or other timeframes corresponding to times of day, days, weeks, months, years, centuries, etc.), one or more portals corresponding to points of interest having imagery corresponding to a current timeframe may be hydrated. For example, a user may play a story of a vacation where portals correspond to photos captured by the user during the vacation may be hydrated accordingly during the story.

Navigation from the scene to other scenes corresponding to points of interest may be facilitated (e.g., a user may freely and/or frictionlessly navigate into buildings, through walls, underground, down streets, around corners, etc.). For example, selection input associated with the first portal may be received (e.g., a user may click or touch the first portal). Responsive to the selection input, the visual interface may be transitioned from the scene to a second scene associated with the first point of interest. For example, the second scene may depict a museum lobby that the user may explore through the second scene. In an example, the second scene may have a second scene orientation that corresponds to a scene orientation of the scene (e.g., as if the user had walked directly into the museum lobby from outside the museum). In an example, one or more portals, corresponding to points of interest within the second scene, may be populated within the second scene (e.g., a portal corresponding to a doorway to a prehistoric portion of the museum; a portal corresponding to a gift shop; etc.). In this way, navigation through the museum may be facilitated. In an example, responsive to receiving a back input (e.g., a user may select a back button or may select outside a scene portal for the second scene), the visual interface may be transitioned from the second scene to the scene of the outside of the museum (e.g., the scene may maintain the scene orientation from before the visual interface was transitioned to the second scene). In this way, the user may freely and/or frictionlessly navigate around scenes and/or preview points of interest before navigating deeper into imagery. At 110, the method ends.

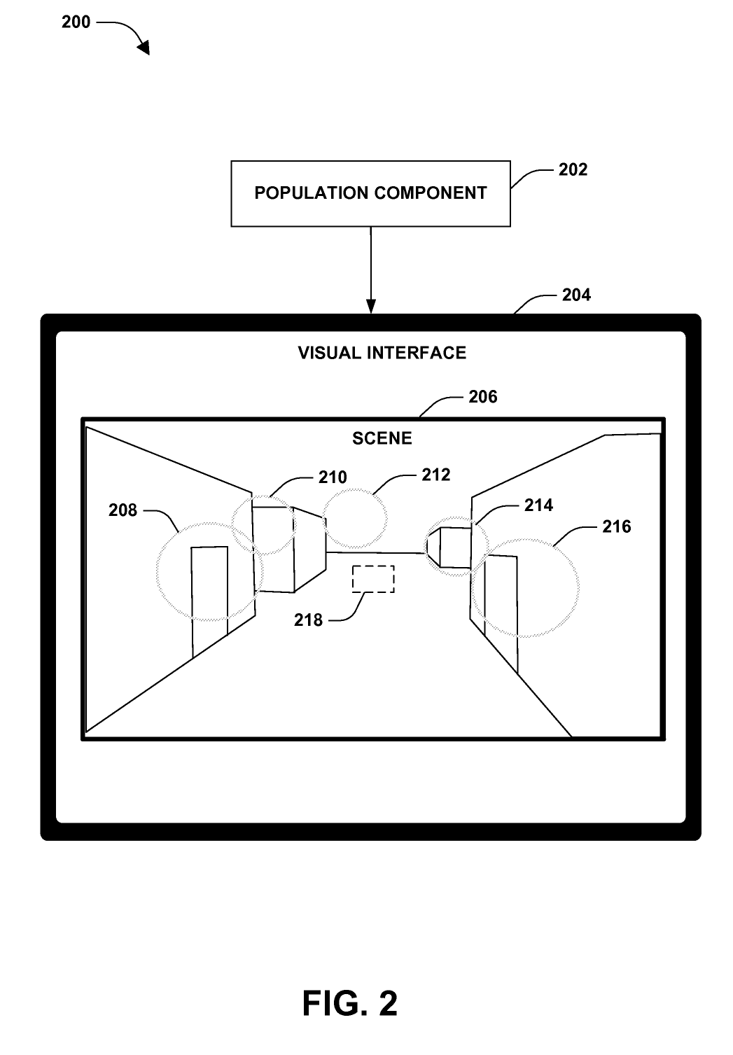

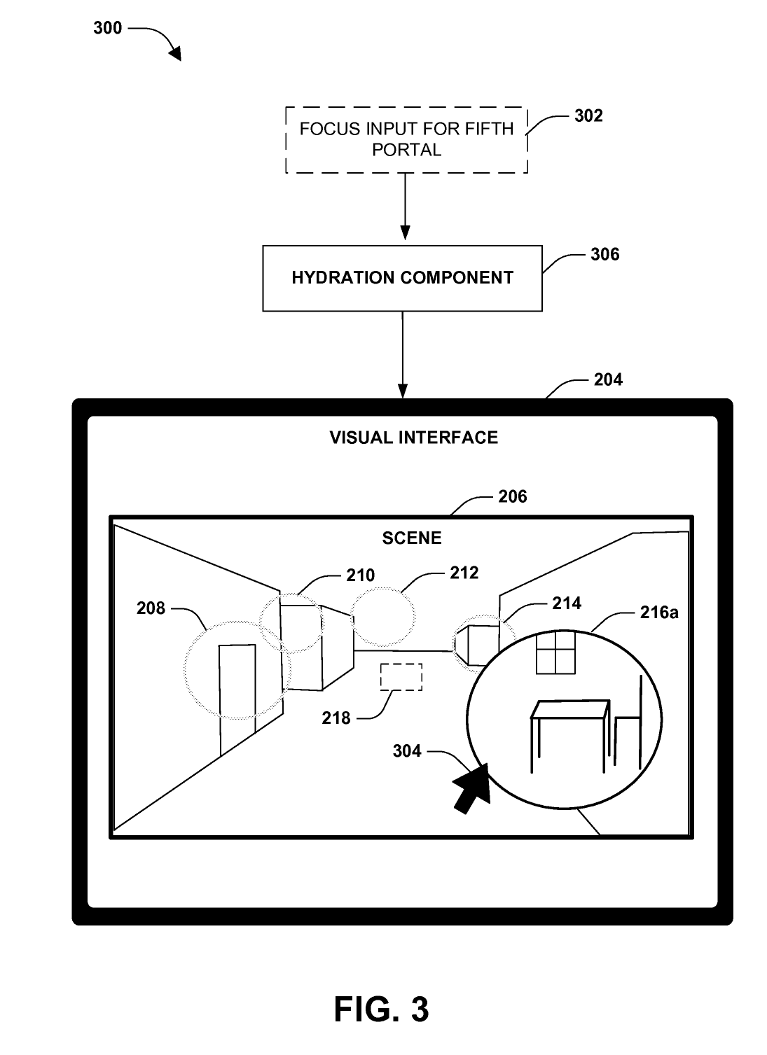

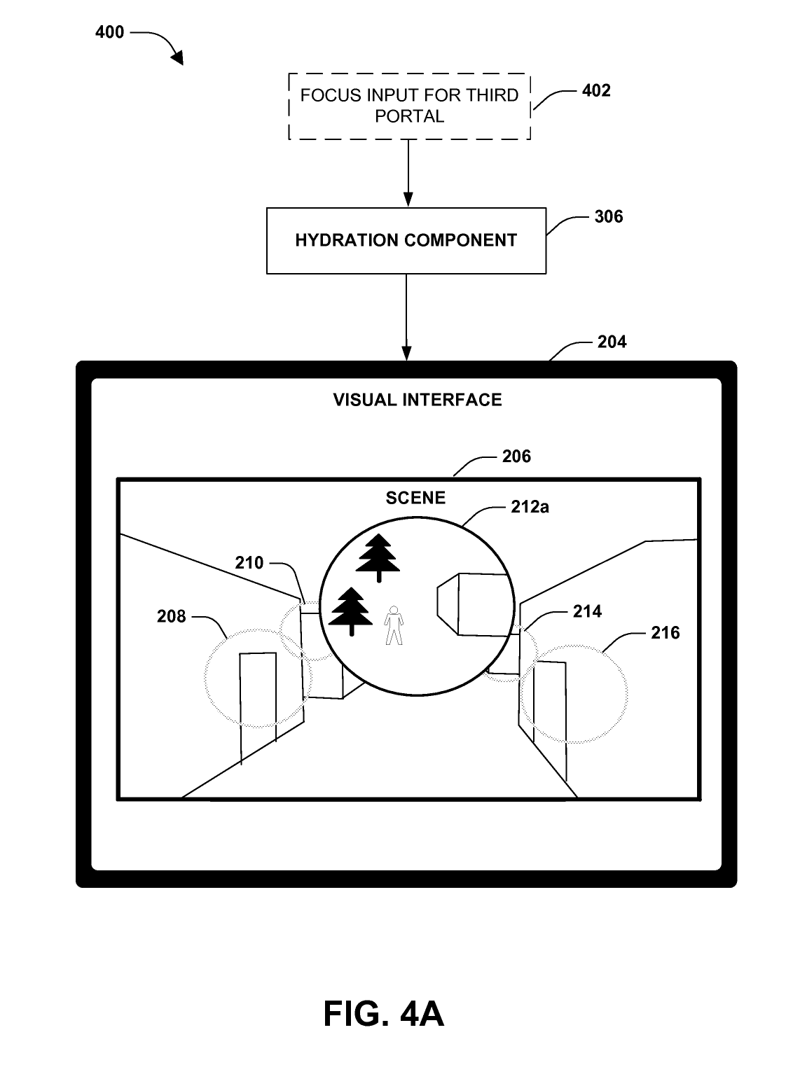

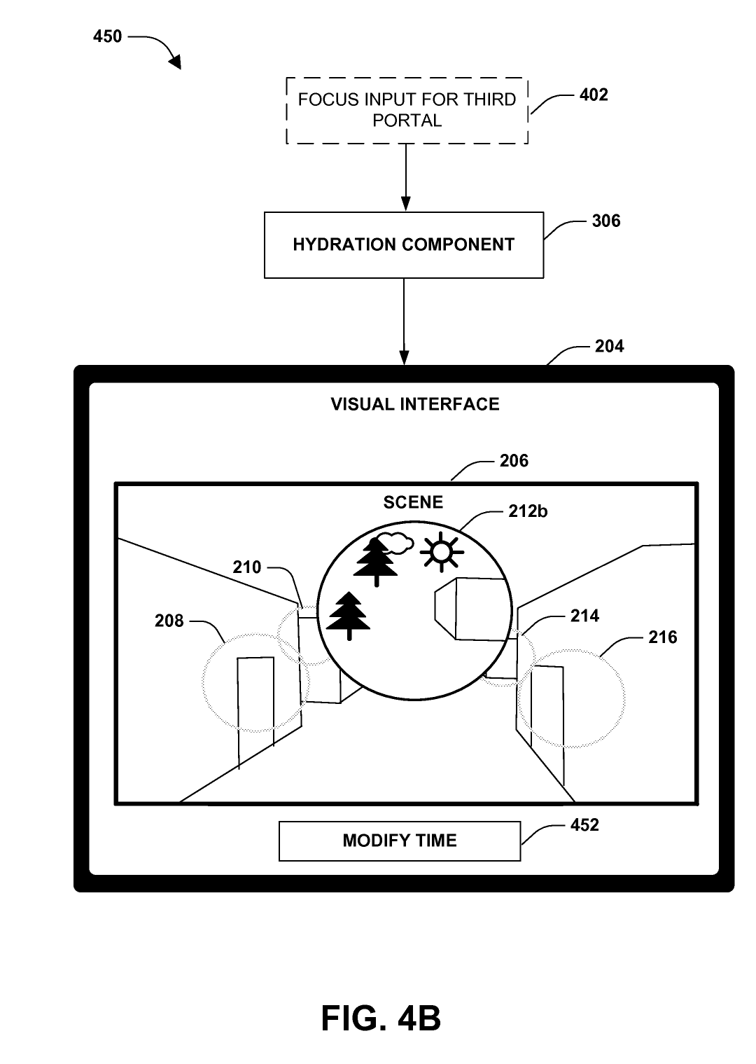

FIG. 2 illustrates an example of a system 200 for populating a scene 206 of a visual interface 204. The system 200 comprises a population component 202. The population component 202 may be configured to display the visual interface 204 depicting the scene 206 (e.g., a rendering component, such as a rendering server, may provide the visual interface 204 to a client device through which the visual interface 204 is displayed). The population component 202 may be configured to identify one or more points of interest within the scene 206 (e.g., a first doorway, a first hallway, a walkway, a second hallway, and a second doorway of the scene 206 of a shopping mall). The population component 202 may be configured to populate the scene 206 with one or more portals corresponding to the points of interest. For example, a first portal 208 may correspond to the first doorway to a clothing store, a second portal 210 may correspond to the first hallway to a mall elevator, a third portal 212 may correspond to the walkway to an outside mall courtyard behind the mall, a fourth portal 214 may correspond to the second hallway of the mall, a fifth portal 216 may correspond to the second doorway to a furniture store, etc. A portal may comprise a semi-transparent perimeter that may encompass at least some of a point of interest, which may mitigate occlusion of the scene 206. The scene 206 may comprise a trigger zone 218, such that a portal may be hydrated with imagery when encountering the trigger zone 218 (e.g., FIG. 4A). A portal may be hydrated with imagery based upon focus input associated with the portal (e.g., FIG. 3).

FIG. 3 illustrates an example of a system 300 for hydrating a portal. The system 300 comprises a hydration component 306. In an example, the hydration component 306 may be associated with a visual interface 204 depicting a scene 206 populated with one or more portals, such as a first portal 208, a second portal 210, a third portal 212, a fourth portal 214, and/or a fifth portal 216 populated by a population component 202, as illustrated in FIG. 2. The hydration component 306 may receive a focus input 302 associated with the fifth portal 216 (e.g., a user may hover over the fifth portal 216 using a cursor 304). Responsive to the focus input 302, the hydration component 306 may hydrate the fifth portal 216 using imagery to create a hydrated fifth portal 216a. For example, the imagery may correspond to photography, a panorama, a manipulatable space, a manipulatable object, and/or other visualization of a furniture store that is a fifth point of interest corresponding to the fifth portal 216.

FIG. 4A illustrates an example of a system 400 for hydrating a portal. The system 400 comprises a hydration component 306. In an example, the hydration component 306 may be associated with a visual interface 204 depicting a scene 206 populated with one or more portals, such as a first portal 208, a second portal 210, a third portal 212, a fourth portal 214, and/or a fifth portal 216 populated by a population component 202, as illustrated in FIG. 2. The hydration component 306 may receive a focus input 402 associated with the third portal 212 (e.g., a user may pan the scene 206 such that the third portal 212 encounters a trigger zone 218 that is illustrated in FIG. 2). Responsive to the focus input 402, the hydration component 306 may hydrate the third portal 212 using imagery to create a hydrated third portal 212a. For example, the imagery may correspond to photography, a panorama, a manipulatable space, a manipulatable object, and/or other visualization of an outside mall courtyard that is a third point of interest corresponding to the third portal 212.

FIG. 4B illustrates an example of a system 450 for hydrating a portal based upon a temporal modification input. The system 400 comprises a hydration component 306. In an example, the hydration component 306 may be associated with a visual interface 204 depicting a scene 206 populated with one or more portals, such as a first portal 208, a second portal 210, a third portal 212, a fourth portal 214, and/or a fifth portal 216 populated by a population component 202, as illustrated in FIG. 2. In an example, the hydration component 306 may have hydrated the third portal 212 with imagery depicting an outside mall courtyard within the last year. Responsive to receiving the temporal modification input (e.g., a user may input Summer 2002 through a modify time interface 452), imagery depicting the outside mall courtyard during the Summer of 2002 may be hydrated within the third portal 212 to create a hydrated third portal 212b.

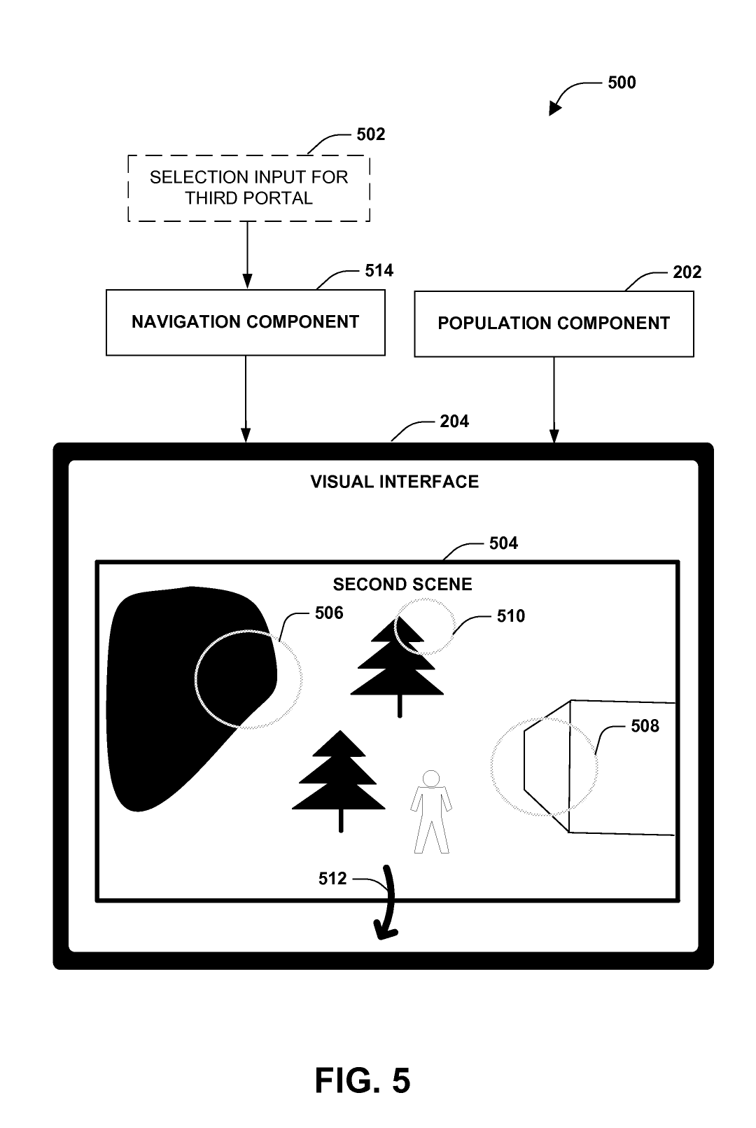

FIG. 5 illustrates an example of a system 500 for navigating between scenes of a visual interface 204. The system 500 comprises a navigation component 514. In an example, the navigation component 514 may be associated with a visual interface 204 depicting a scene 206 populated with one or more portals, such as a first portal 208, a second portal 210, a third portal 212, a fourth portal 214, and/or a fifth portal 216 populated by a population component 202, as illustrated in FIG. 2. The navigation component 502 may receive a selection input 502 associated with the third portal 212 (e.g., a user may have selected the third portal 212 corresponding to a third point of interest of an outside mall courtyard). Responsive to the selection input 502, the navigation component 514 may transition the visual interface 204 from the scene 206 to a second scene 504 corresponding to the third point of interest of the outside mall courtyard. The population component 202 may populate the second scene 504 with portals corresponding to one or more points of interest for the second scene 504, such as sixth portal 506 corresponding to a pond, a seventh portal 508 corresponding to a building, and/or an eighth portal 510 corresponding to a tree. A back button interface 512 may be used by a user to transition the visual interface 204 from the second scene 504 to the scene 206.

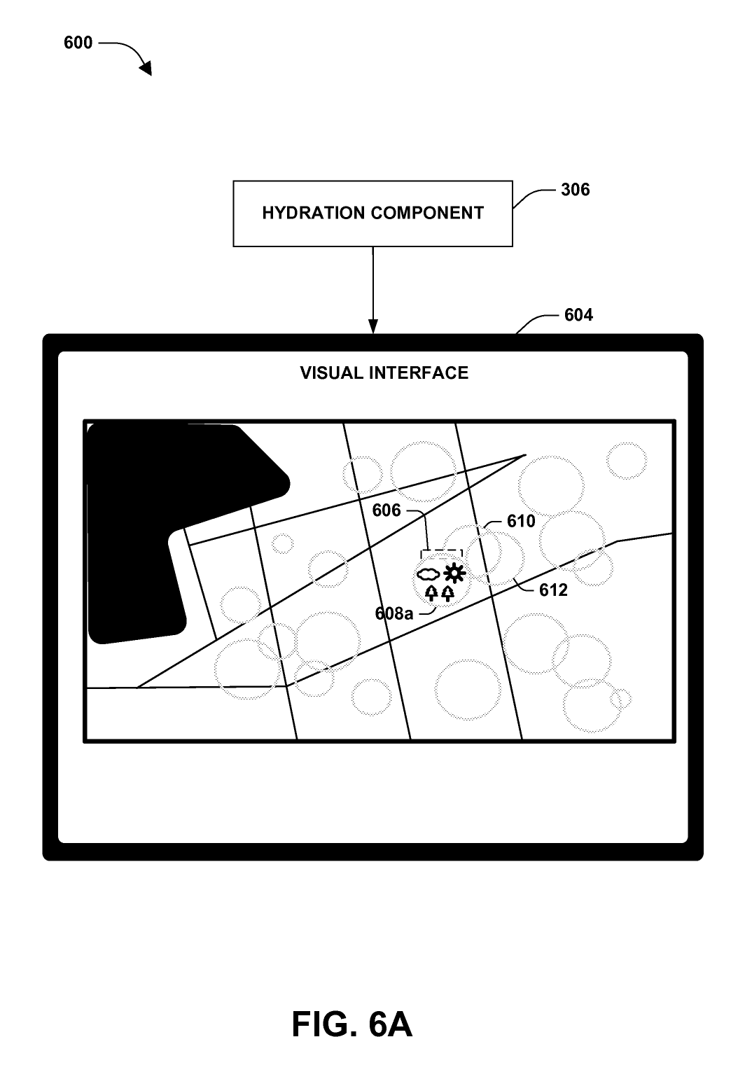

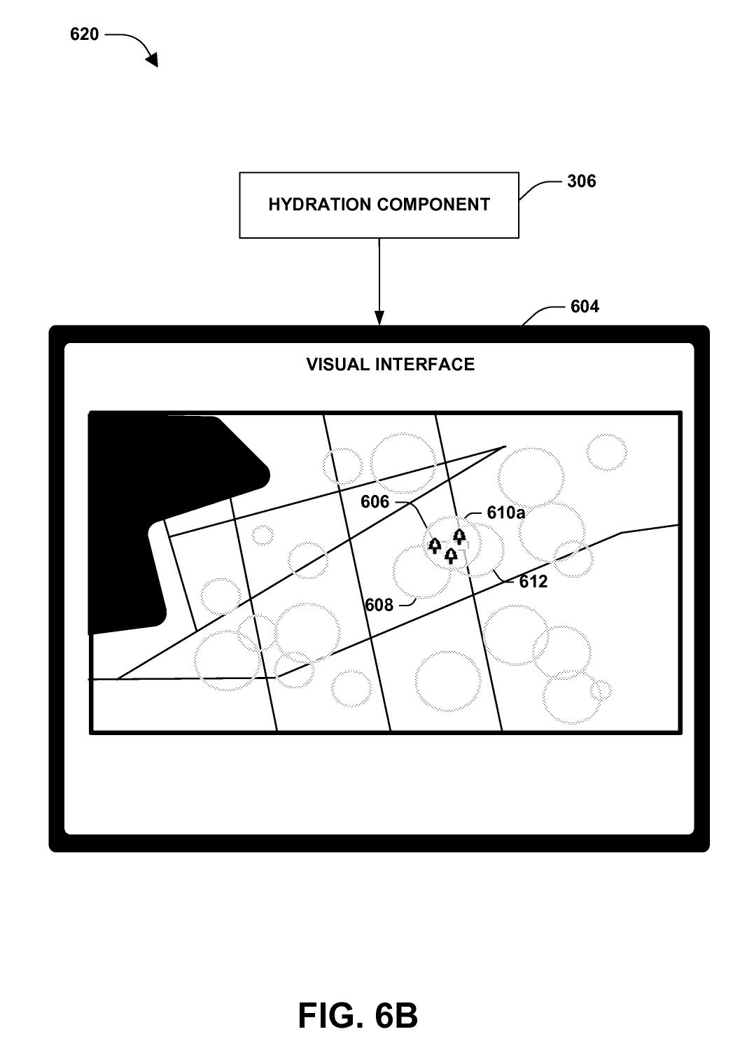

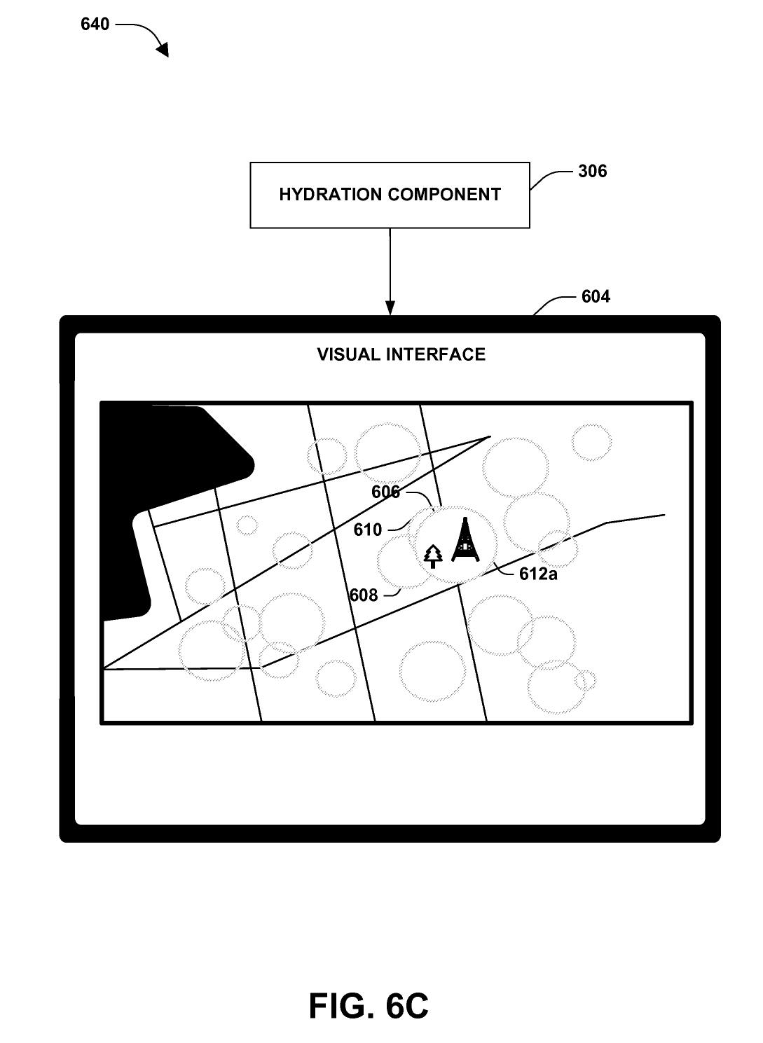

FIG. 6A illustrates an example of a system 600 for facilitating visual navigation between a plurality of portals. The system 600 may comprise a hydration component 306. In an example, the hydration component 306 may be associated with a visual interface 604 depicting a scene (e.g., a scene of a residential neighborhood). The scene may have been populated with a plurality of portals, such as a first portal 608, a second portal 610, a third portal 612, and/or other portals. The scene may comprise a trigger zone 606 such that when a portal encounters the trigger zone 606 (e.g., a portal having a center point closest to a trigger zone center point, such that merely a single portal is determine to be “encountering” the trigger zone 606 at a time; a portal having an amount of overlap with the trigger zone 606 above a threshold; horizontal alignment; vertical alignment; etc.), the portal is hydrated with imagery depicting a point of interest corresponding to the portal. For example, responsive to the first portal 608 encountering the trigger zone 606 (e.g., the first portal 608 may have greater horizontal alignment with the trigger zone 606 than the second portal 610 and/or the third portal 612), the first portal 608 may be hydrated with imagery to create a hydrated first portal 608a. In an example, the first hydrated portal 608a may be displayed on top of the second portal 610 and/or the third portal 612.

FIG. 6B illustrates an example of a system 620 for facilitating visual navigation between a plurality of portals. The system 620 may comprise a hydration component 306. In an example, the hydration component 306 may be associated with a visual interface 604 depicting a scene (e.g., a scene of a residential neighborhood). The scene may have been populated with a plurality of portals, such as a first portal 608, a second portal 610, a third portal 612, and/or other portals. The scene may comprise a trigger zone 606 such that when a portal encounters the trigger zone 606 (e.g., a portal having a center point closest to a trigger zone center point, such that merely a single portal is determine to be “encountering” the trigger zone 606 at a time; a portal having an amount of overlap with the trigger zone 606 above a threshold; horizontal alignment; vertical alignment; etc.), the portal is hydrated with imagery depicting a point of interest corresponding to the portal. In an example, the first portal 608 may have been hydrated to create a hydrated first portal 608a based upon the first portal 608 encountering the trigger zone 606 (e.g., FIG. 6A). A user may pan the visual interface 604 such that the second portal 610, but not the first portal 608, is determined as encountering the trigger zone 606. Accordingly, the hydrated first portal 608a may be dehydrated resulting in the first portal 608, and the second portal 610 may be hydrated with imagery to create a hydrated second portal 610a.

FIG. 6C illustrates an example of a system 640 for facilitating visual navigation between a plurality of portals. The system 640 may comprise a hydration component 306. In an example, the hydration component 306 may be associated with a visual interface 604 depicting a scene (e.g., a scene of a residential neighborhood). The scene may have been populated with a plurality of portals, such as a first portal 608, a second portal 610, a third portal 612, and/or other portals. The scene may comprise a trigger zone 606 such that when a portal encounters the trigger zone 606 (e.g., a portal having a center point closest to a trigger zone center point, such that merely a single portal is determine to be “encountering” the trigger zone 606 at a time; a portal having an amount of overlap with the trigger zone 606 above a threshold; horizontal alignment; vertical alignment; etc.), the portal is hydrated with imagery depicting a point of interest corresponding to the portal. In an example, the second portal 610 may have been hydrated to create a hydrated second portal 610a based upon the second portal 610 encountering the trigger zone 606 (e.g., FIG. 6B). A user may pan the visual interface 604 such that the third portal 612, but not the second portal 608, is determined as encountering the trigger zone 606. Accordingly, the hydrated second portal 610a may be dehydrated resulting in the second portal 610. The third portal 612 may be hydrated with imagery to create a hydrated third portal 612a. In an example, a size and/or transparency of the third hydrated portal 612 may be modified (e.g., increased size and/or decreased transparency) based upon the third portal 612 encountering the trigger zone 606.

FIG. 7A illustrates an example of a system 700 for facilitating a story mode. The system 700 may comprise a hydration component 306. In an example, the hydration component 306 may be associated with a visual interface 702 depicting a scene (e.g., a scene of a town visited by a user on vacation). The scene may have been populated with a plurality of portals, such as a first portal 704, a second portal 706, a third portal 708, and/or other portals. A story mode selection input may be received through a story mode interface 701. Responsive to the story mode selection input, a story timeline interface 710 may be provided. In an example, the story timeline interface 710 may correspond to a start time 714 of the vacation and an end time 716 of the vacation (e.g., as determined based upon temporal metadata, such as capture dates, of imagery captured by the user while in the town). A current time marker 712 may be used to specify a current timeframe for which a portal corresponding to a point of interest for the current timeframe may be hydrated. For example, the current time marker 712 may correspond to Tuesday afternoon (e.g., the user may move the current time marker 712 to a position along the storyline interface 710 corresponding to Tuesday afternoon or the current time marker 712 may encounter the position based upon a play story setting). The user may have captured imagery of a first point of interest corresponding to the first portal 704 on Tuesday afternoon. Accordingly the first portal 704 may be hydrated with the imagery to create a hydrated first portal 704a.

FIG. 7B illustrates an example of a system 720 for facilitating a story mode. The system 720 may comprise a hydration component 306. In an example, the hydration component 306 may be associated with a visual interface 702 depicting a scene (e.g., a scene of a town visited by a user on vacation). The scene may have been populated with a plurality of portals, such as a first portal 704, a second portal 706, a third portal 708, and/or other portals. In an example, the first portal 704 may have been hydrated with imagery captured on Tuesday afternoon by the user based upon a current time marker 712, of a story timeline interface 710, corresponding to Tuesday afternoon (e.g., FIG. 7A). Responsive to the current time marker 712 corresponding to a Wednesday night (e.g., a position along the story timeline interface 710 corresponding to Wednesday night), imagery captured by the user on Wednesday night (e.g., imagery captured at a second point of interest corresponding to the second portal 706) may be used to hydrate the second portal 706 to create a hydrated second portal 706a.

FIG. 7C illustrates an example of a system 740 for facilitating a story mode. The system 740 may comprise a hydration component 306. In an example, the hydration component 306 may be associated with a visual interface 702 depicting a scene (e.g., a scene of a town visited by a user on vacation). The scene may have been populated with a plurality of portals, such as a first portal 704, a second portal 706, a third portal 708, and/or other portals. In an example, the first portal 704 may have been hydrated with imagery captured on Tuesday afternoon by the user based upon a current time marker 712, of a story timeline interface 710, corresponding to Tuesday afternoon (e.g., FIG. 7A), and then a second portal 706 may have been hydrated with imagery captured on a Wednesday night based upon the current time marker 712 corresponding to Wednesday night (e.g., FIG. 7B). Responsive to the current time marker 712 corresponding to a Saturday morning (e.g., a position along the story timeline interface 710 corresponding to Saturday morning), imagery captured by the user on Saturday morning (e.g., imagery captured at a third point of interest corresponding to the third portal 708) may be used to hydrate the third portal 708 to create a hydrated third portal 708a.

FIG. 8 illustrates an example of a system 800 for populating a scene 204 of a kinetic map visual interface 814. The system 800 may comprise a population component 202. The population component 202 may be configured to identify one or more points of interest within the scene 204 (e.g., a park, a lake, a condo, etc.). The population component 202 may be configured to populate the scene 204 with portals corresponding to the points of interest, such as a first portal 804, a second portal 806, and/or a third portal 808. The first portal 804, the second portal 806, and/or the third portal 808 may be displayed at a portal scale that is greater than a collapsed scale at which non-portal portions of the scene 204 are displayed. For example, a first non-portal portion 812 and/or a second non-portal portion 810 may correspond to hundreds of miles of uninteresting highway, and thus may be displayed at the collapsed scale.

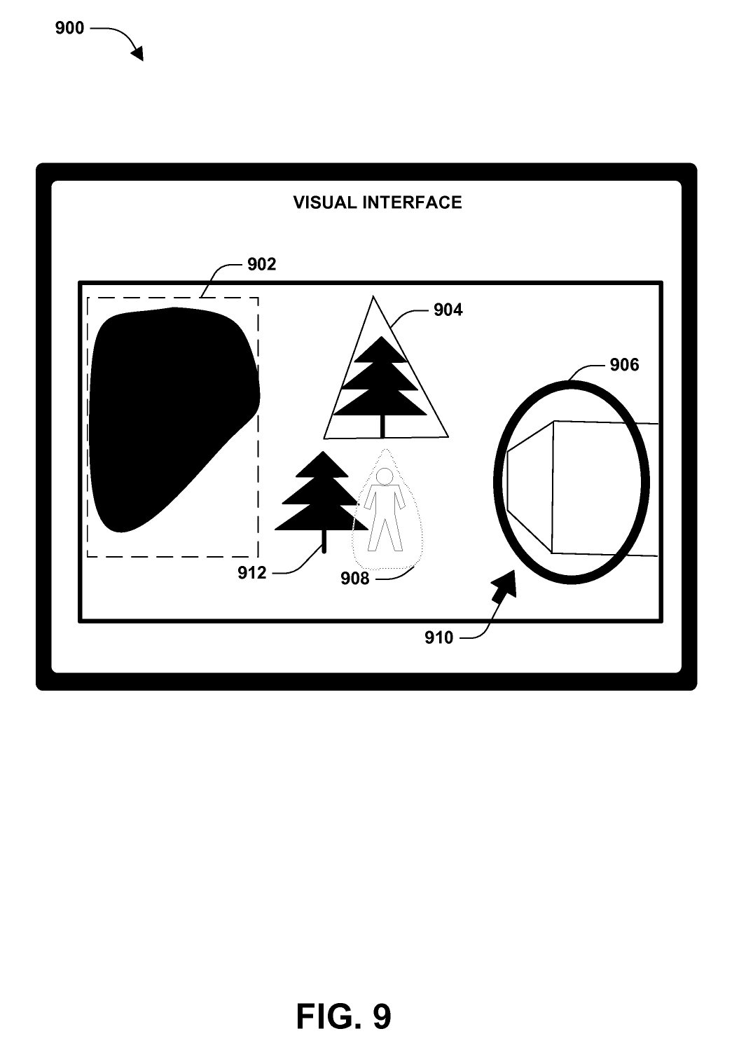

FIG. 9 illustrates an example 900 of various portals. It may be appreciated that a portal, such as a graphical user interface element (e.g., a programming object, a web interface object, and/or other control object(s) created using a programming language such HTML, JAVA script, Silverlight, .NET, DirectX, etc.), may have various shapes, sizes, colors, visual properties (e.g., a transparency property) and/or configurations, which may dynamically change based upon various factors (e.g., a size of a portal may increase as a user pans towards the portal; a transparency of the portal may decrease as the user pans away from the portal; a visual property such as a BackgroundImage property may be set to imagery of a point of interest associated with the portal responsive to the user hovering over and/or otherwise interacting with the portal, etc.). In an example, a first portal 902 may have a rectangular shape that outlines a lake point of interest. The first portal 902 may have a perimeter comprising a dashed line. In another example, a second portal 904 may have a triangular shape that outlines a tree point of interest with a thin solid line. In another example, a third portal 906 may have an oval shape that encompasses at least some of a building point of interest with a thick solid line. The third portal 906 may, for example, have a relatively thicker perimeter line than other portals based upon a curser 910 being positioned relatively closer to the third portal 906 than the other portals (e.g., a thickness of the perimeter line of the third portal 906 may increase as the curser 910 is moved towards the third portal 906 and may decrease as the curser 910 is moved away from the third portal 906 or vice versa). In another example, a fourth portal 908 may have a rain drop shape or any other shape. A perimeter of the fourth portal 908 may be semi-transparent to mitigate occlusion of an underlying scene, such as a tree 912. In this way, a portal may be generated according to various shapes, sizes, colors, visual properties, and/or configurations, and is not limited to the examples provided.

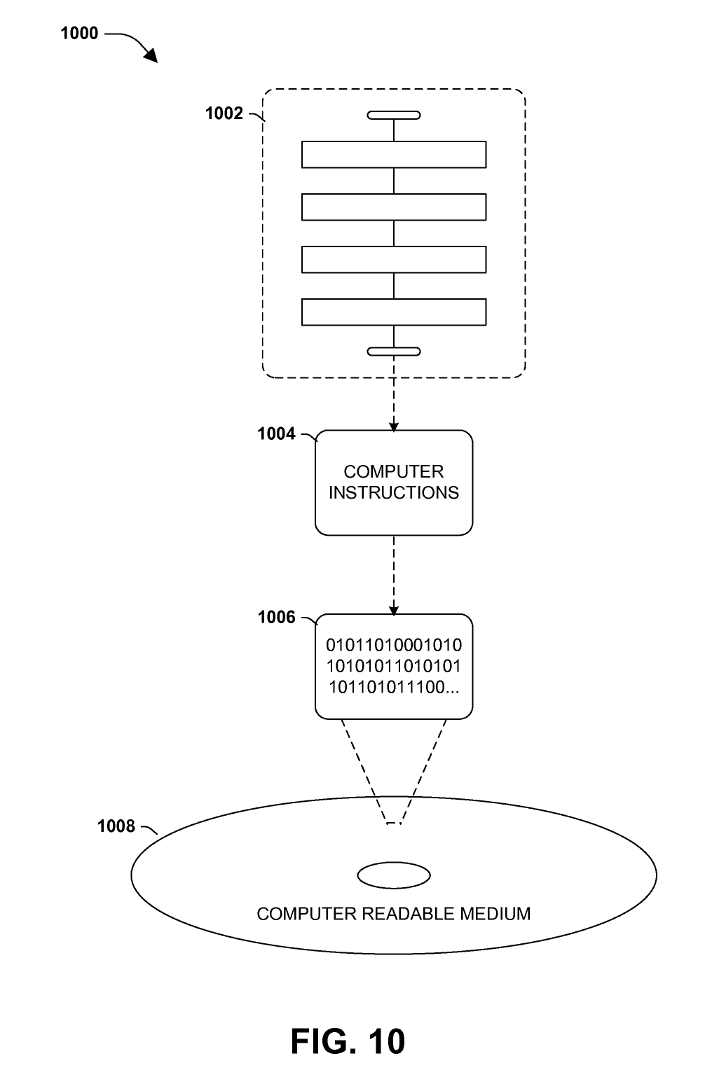

Still another embodiment involves a computer-readable medium comprising processor-executable instructions configured to implement one or more of the techniques presented herein. An example embodiment of a computer-readable medium or a computer-readable device is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 100 of FIG. 1, for example. In some embodiments, the processor-executable instructions 1004 are configured to implement a system, such as at least some of the exemplary system 200 of FIG. 2, at least some of the exemplary system 300 of FIG. 3, at least some of the exemplary system 400 of FIG. 4A, at least some of the exemplary system 450 of FIG. 4B, at least some of the exemplary system 500 of FIG. 5, at least some of the exemplary system 600 of FIG. 6A, at least some of the exemplary system 620 of FIG. 6B, at least some of the exemplary system 640 of FIG. 6C, at least some of the exemplary system 700 of FIG. 7A, at least some of the exemplary system 720 of FIG. 7B, at least some of the exemplary system 740 of FIG. 7C, and/or at least some of the exemplary system 800 of FIG. 8, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

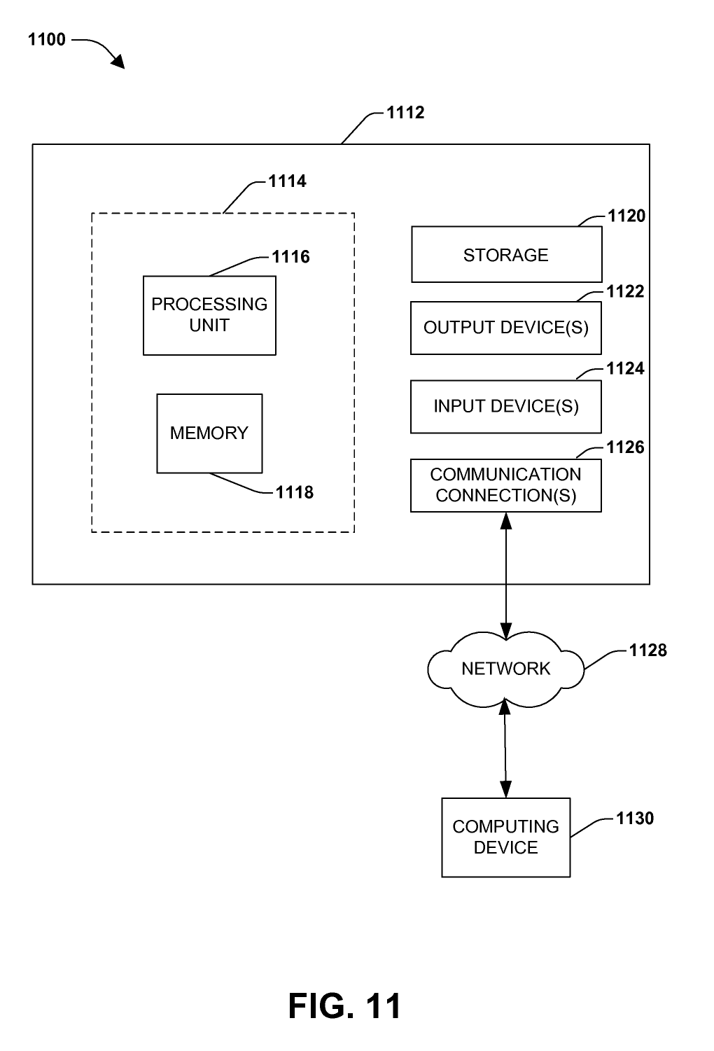

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Computer storage media does not, however, include propagated signals. Rather, computer storage media excludes propagated signals. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for populating a scene of a visual interface with a portal, comprising:
displaying a visual interface depicting a scene;
identifying a first point of interest within the scene; and
populating the scene with a first portal corresponding to the first point of interest.

2. The method of claim 1, the scene comprising at least one of a map, photography, a manipulatable object, a panorama, a rendering, an image, or a visualization.

3. The method of claim 1, comprising:
displaying the first portal at a first scale; and
displaying a non-portal portion of the scene at a collapsed scale smaller than the first scale.

4. The method of claim 1, comprising:
responsive to receiving focus input associated with the first portal, hydrating the first portal with imagery corresponding to the first point of interest to create a first hydrated portal.

5. The method of claim 4, the imagery comprising at least one of photography depicting the first point of interest, a panorama, 3D imagery, a streetside view of the first point of interest, an interactive manipulatable space, or an interactive manipulatable object.

6. The method of claim 4, the focus input corresponding to at least one of a hover over input or a navigational input for the scene that places the first portal within a trigger zone.

7. The method of claim 4, comprising:
adjusting a transparency property of the first hydrated portal.

8. The method of claim 4, the imagery depicting the first point of interest according to a portal orientation corresponding to a scene orientation of the scene.

9. The method of claim 1, comprising:
responsive to receiving selection input associated with the first portal, transitioning the visual interface to a second scene associated with the first point of interest.

10. The method of claim 9, the second scene having a second scene orientation corresponding to a scene orientation of the scene.

11. The method of claim 9, comprising:
responsive to receiving back input, transitioning the visual interface from the second scene to the scene.

12. The method of claim 1, comprising:
populating the scene with a plurality of portals corresponding to points of interest associated with the scene.

13. The method of claim 12, the populating the scene with a plurality of portals comprising:
identifying a point of interest density for the scene; and
modifying at least one of a size, a transparency, or a display property for respective portals of the plurality of portals based upon the point of interest density.

14. The method of claim 12, comprising:
for respective portals encountering a trigger zone of the visual interface, hydrating a portal while the portal encounters the trigger zone and dehydrating the portal responsive to the portal no longer encountering the trigger zone.

15. The method of claim 14, comprising:
while the portal encounters the trigger zone:
responsive to identifying an overlap between the portal and one or more portals, displaying the portal on top of the one or more portals.

16. The method of claim 4, comprising:
responsive to receiving a temporal modification input, modifying the imagery within the first hydrated portal based upon the temporal modification input.

17. The method of claim 1, comprising:
receiving a temporal modification input;
responsive to determining that the first point of interest does not correspond to the temporal modification input, removing the first portal; and
responsive to determining that a second point of interest corresponds to the temporal modification input, populating the scene with a second portal corresponding to the second point of interest.

18. The method of claim 1, comprising:
responsive to receiving a story mode selection input:
for respective timeframes of a story, hydrating one or more portals corresponding to points of interest having imagery corresponding to a timeframe.

19. A system for populating a scene of a visual interface with a portal, comprising:
a population component configured to:
display a visual interface depicting a scene;
identify a first point of interest within the scene; and
populate the scene with a first portal corresponding to the first point of interest;
a hydration component configured to:
responsive to receiving focus input associated with the first portal, hydrate the first portal with imagery corresponding to the first point of interest to create a first hydrated portal; and
a navigation component configured to:
responsive to receiving selection input associated with the first portal, transition the visual interface to a second scene associated with the first point of interest.

20. A computer readable medium comprising instructions which when executed perform a method for populating a scene of a visual interface with a portal, comprising:
displaying a visual interface depicting a scene;
identifying a first point of interest within the scene; and
populating the scene with a first portal corresponding to the first point of interest.
